(19) United States
(12) Patent Application Publication
(10) Pub. No.: US 2015/0101483 A1
(43) Pub. Date: Apr. 16, 2015

(54) HIGH PERFORMANCE ADSORBENT MEDIA FOR CONCENTRATOR SYSTEMS

(71) Applicant: MeadWestvaco Corporation, Richmond, VA (US)

(72) Inventors: John D. PERRY, Mount Pleasant, SC (US); Paula S. WALMET, Mount Pleasant, SC (US)

(21) Appl. No.: 14/511,611

(22) Filed: Oct. 10, 2014

Related U.S. Application Data
(60) Provisional application No. 61/889,721, filed on Oct. 11, 2013.

(51) Int. Cl. B01J 20/28; B01J 20/20; B01D 53/06

(52) U.S. Cl. CPC B01J 20/28069; B01D 53/06; B01J 20/28045; B01J 20/20; B01J 20/28011; B01D 2253/102; B01D 2253/20; B01D 2253/3425; B01D 2253/311
USPC 95/148; 96/108; 96/143; 96/125; 96/144; 428/116; 502/400; 502/416; 502/60; 502/401; 502/407; 502/415

(57) ABSTRACT

An adsorbent media has a pore volume/media volume of at least about 0.12 cc pore volume/cc media, a specific heat capacity of less than about 2.9 J/cc pore volume, and a pressure drop of less than about 4.0 inH₂O/ft media at a superficial air velocity of about 500 ft/min, wherein the adsorbent media is in a concentrator system. An extruded honeycomb adsorbent media has a cell density of more than about 200 cells per square inch (cspi), % open area of at least about 50%, an activated carbon content of at least about 50% by weight based on total weight, and a pressure drop of less than about 4.0 inH₂O/ft media at a superficial fluid velocity of about 500 ft/min.

### CROSS REFERENCE TO RELATED APPLICATION

This application claims the benefit of U.S. Provisional Application No. 61/889,721 filed Oct. 11, 2013, and incorporates the same herein by reference in its entirety.

### FIELD OF THE INVENTION

The present disclosure, in various embodiments, relates generally to adsorbent media for removal of contaminants from contaminant-laden fluid streams, to methods relating to such adsorbent media, and to concentrator systems including such adsorbent media.

### BACKGROUND

A substantial portion of the industrial air pollution concerns an emission of large volumes of gas stream contaminated with very low concentrations of organic vapors. Due to the large volumes of gas stream and the relatively low concentrations of contaminants in the gas stream, it is difficult and costly to effectively remove contaminants from the gas stream.

Solvent concentrators have been used to remove solvents from the solvent-laden gas stream, where the solvent-laden gas stream has large volumes and contains very low concentrations of solvent. During adsorption cycle, large volumes of the solvent-laden gas stream are directed to the adsorbent media in solvent concentrator, and solvent in the solvent-laden gas steam is adsorbed onto the adsorbent media. During desorption cycle, a relatively small volumes of purge stream (e.g., separate clean gas steam) are directed to the adsorbent media, and the solvent adsorbed on the adsorbent media is desorbed into the relatively small volumes of purge stream. With the use of the solvent concentrator, solvent can be desorbed into relatively small volumes of purge stream (e.g., 20 times less volume compared to the large volumes of solvent-laden gas stream). The relatively small volumes of purge stream containing the desorbed contaminant are then directed to an abatement system, such as an incinerator. Since the relatively small volumes of solvent-laden purge stream, rather than the original large volume of solvent-laden gas stream, are treated in the abatement system, the operation cost can be reduced with the use of solvent concentrator. For example, solvent concentrators have been used for removal of solvent vapors in automotive spray booth air where relatively small amounts of volatile organic compounds (VOCs) are present in large volumes of solvent-laden air. The efforts to further improve the efficiency and economy of solvent concentrators have led to rotary solvent concentrator systems, where a continuous cleaning of the high volume solvent-laden air by adsorbent media in the rotary adsorbent units and desorbing of the adsorbed solvent from the adsorbent media in the rotary adsorbent units may be achieved.

U.S. Pat. No. 4,409,006 discloses a concentrator system that includes adsorbent units containing either granular, fibrous or porous adsorbents, such as activated carbon, molecular sieve, silica gel, or other suitable adsorbents. The concentrator system suffers from high pressure drop, since granular, fibrous and porous adsorbents impart significant gas flow resistance.

To minimize pressure drop and further improve economy of the concentrator systems, honeycomb adsorbent media has been used as an adsorbent media in the concentrator systems. The honeycomb adsorbent has parallel passages defined by its cell walls for gas stream to flow through; therefore, the gas flow resistance may be significantly reduced when honeycomb adsorbent media is used.

The honeycomb adsorbent media may be constructed from alternating layers of flat and corrugated cellulosic and/or ceramic fibrous sheets, which are bound or laminated together to form a honeycomb structure with parallel passages. The honeycomb structure is then impregnated with slurry comprising adsorbent material, binder, and a solvent. Subsequently, the solvent is evaporated, leaving the adsorbent material dispersed in fiber gaps and on the surfaces of the passage walls of the honeycomb structure. See, e.g., U.S. Pat. No. 5,348,922; PCT Application Publication No. WO 2004/011126 A1; U.S. Pat. No. 5,980,612. For solvent concentrator system, these honeycomb adsorbent media has several deficiencies. For example, during the production of honeycomb adsorbent media, the adsorbent material in the slurry may plug the passages of the honeycomb structure, rather than coating them, resulting in a lower adsorption capacity and an increased flow resistance. Furthermore, the honeycomb adsorbent media with small passage width is typically difficult to attain without the adsorbent material being plugged in the passages of the honeycomb structure. Additionally, these honeycomb adsorbent media often has relatively short life cycle and exhibit poor structure strength, especially under high humidity conditions.

The honeycomb adsorbent media prepared by extrusion technique (i.e., extruded honeycomb adsorbent media) has been used for solvent concentrator systems. However, extruded media has been previously resisted in the solvent concentrator industry because of the higher density and higher total heat capacity of the media (leading to higher heat load within the system).”

### DESCRIPTION OF THE DRAWINGS

FIG. 1 is a graph showing a specific heat capacity per media volume of different honeycomb adsorbent media at different temperatures; and

FIG. 2 is a graph showing a specific heat capacity per pore volume of different honeycomb adsorbent media at different temperatures.

### DESCRIPTION

The present disclosure now will be described more fully hereinafter, but not all embodiments of the disclosure are shown. While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular structure or material to the teachings of the disclosure without departing from the essential scope thereof.

The term “fluid stream,” as used herein, means and includes gas stream, liquid stream, or combinations thereof.

The term “honeycomb structure,” as used herein, means and includes a porous structure defined by a plurality of substantially parallel thin channels extending therethrough.

In a particular embodiment, an extruded honeycomb adsorbent media is characterized by a cell density of more than about 200 cells per square inch (cspi), % open area of at least about 50%, an activated carbon content of at least about 50% by weight based on total weight, and a pressure drop of less than about 4.0 inH₂O/ft media at a superficial fluid velocity of about 500 ft/min.

In some embodiments, the extruded honeycomb adsorbent media may have a pore volume/media volume of at least about 0.12 cc pore volume/cc media. The pore volume measurement is based on the volume greater than 320 angstroms as measured by N2 porosimetry.

In some embodiments, the extruded honeycomb adsorbent media may have a specific heat capacity of less than about 2.9 J/cc pore volume.

In some embodiments, the extruded honeycomb adsorbent media may have a cell density of about 400 cells per square inch (cspi).

In some embodiments, the extruded honeycomb adsorbent media may have % open area of about 65%.

By way of non-limiting example, the disclosed extruded honeycomb adsorbent media may be produced as described in the U.S. Pat. No. 5,914,294. The activated carbon in the extruded honeycomb adsorbent media may be derived from any known carbon precursors. Non-limiting examples of the carbon precursors may include wood, wood dust, wood flour, cotton linters, peat, coal, lignite, petroleum pitch, petroleum coke, coal tar pitch, carbohydrates, coconut, fruit pits, fruit stones, nut shells, nut pits, sawdust, palm, vegetables, synthetic polymer, natural polymer, lignocellulosic material, or combinations thereof.

In a particular embodiment, a concentrator system comprises at least one extruded honeycomb adsorbent media. The extruded honeycomb adsorbent media is characterized by a cell density of more than about 200 cells per square inch (cspi), % open area of at least about 50%, an activated carbon content of at least about 50% by weight based on total weight, and a pressure drop of less than about 4.0 inH₂O/ft media at a superficial fluid velocity of about 500 ft/min.

In some embodiments, at least one of the extruded honeycomb adsorbent media may have a pore volume/media volume of at least about 0.12 cc pore volume/cc media and a specific heat capacity of less than about 2.9 J/cc pore volume.

During adsorption cycle of the concentrator system, large volumes of fluid stream containing small amounts of contaminant are directed to the concentrator system. The contaminant-laden fluid stream contacts the disclosed extruded honeycomb adsorbent media in the concentrator system, and the contaminant in the fluid stream is adsorbed onto the extruded honeycomb adsorbent media. The fluid stream exiting the concentrator system may have a significantly reduced amount of contaminant, or may be substantially free of the contaminant.

During desorption cycle of the concentrator system, relatively small volumes of purge stream (e.g., separate clean fluid stream) are directed to the disclosed extruded honeycomb adsorbent media of the concentrator system to desorh the adsorbed contaminant from the extruded honeycomb adsorbent media into the relatively small volumes of purge stream. Then, the relatively small volumes of contaminant-laden purge stream exit the concentrator system for further processing. By way of non-limiting example, the relatively small volumes of contaminant-laden purge stream may be directed to an abatement system, such as an incinerator to destroy the contaminant.

Accordingly, in one particular embodiment, a method of removing contaminant from fluid stream containing contaminant comprises contacting the fluid stream containing contaminant with at least one extruded honeycomb adsorbent media in a concentrator system to adsorb the contaminant onto at least one of the extruded honeycomb adsorbent media; and desorbing the adsorbed contaminant from at least one of the extruded honeycomb adsorbent media. The extruded honeycomb adsorbent media has a cell density of more than about 200 cells per square inch (cspi), % open area of at least about 50%, an activated carbon content of at least about 50% by weight based on total weight, and a pressure drop of less than about 4.0 inH₂O/ft media at a superficial fluid velocity of about 500 ft/min.

In some embodiments, the method may use the extruded honeycomb adsorbent media having a pore volume/media volume of at least about 0.12 cc pore volume/cc media and a specific heat capacity of less than about 2.9 J/cc pore volume.

The concentrator system may utilize heat energy to enhance desorption of the adsorbed contaminant from the extruded honeycomb adsorbent media during desorption cycle. By way of non-limiting examples: heat may be applied to the extruded honeycomb adsorbent media during desorption cycle, or the purge stream for desorbing the adsorbed contaminant may be heated, or both. Heat may be applied to the extruded honeycomb adsorbent media during desorption cycle by any conventional method. Non-limiting examples of heating methods may include electrically heating, resistive heating, or heat exchanging.

In some embodiments, the relatively small volumes of purge stream directed to the extruded honeycomb adsorbent media during desorption cycle may be heated. The heated purge stream (e.g., hot air) may be forced through the parallel passages of the extruded honeycomb adsorbent media, allowing desorption of the adsorbed contaminant from the extruded honeycomb adsorbent media.

In some embodiments, the concentrator system may further include a heat supply component held in contact with or bonded to at least one of the extruded honeycomb adsorbent media in the concentrator system. The heat supply component may transfer heat to the extruded honeycomb adsorbent media mainly through heat conduction.

In some embodiments, the concentrator system may include at least one honeycomb adsorbent media comprising an activated carbon content in an amount of at least about 50% by weight based on total weight, a binder and an electrically conductive material; and an electric current supply configured to provide a current to at least one of the extruded honeycomb adsorbent media during desorption cycle to enhance desorption of the adsorbed contaminant. Non-limiting examples of the electrically conductive materials may include carbon or metal shaving. Non-limiting examples of the binder may include ceramic, clay, cordierite, flux, glass ceramic, metal, mullite, corrugated paper, organic fibers, resin binder, talc, alumina powder, magnesia powder, silica powder, kaolin powder, sinterable inorganic powder, fusible glass powder, or combinations thereof.

As heat has typically been used to enhance the desorption of the adsorbed contaminant from the adsorbent media in the concentrator systems, it is desirable that the adsorbent media has a low specific heat capacity so that low amounts of heat energy are needed to enhance desorption.

It is a general knowledge that the higher the density of the adsorbent media, the higher the specific heat capacity of the adsorbent media on a volumetric basis, and consequently the higher amounts of energy required to heat the adsorbent media. One skilled in the art recognizes that the extruded honeycomb adsorbent media has a higher density than the honeycomb adsorbent media constructed from fibrous sheets. Thus, one skilled in the art expects that the extruded honeycomb adsorbent media would have a higher specific heat capacity than the honeycomb adsorbent media constructed from fibrous sheets, and that the extruded honeycomb adsorbent media would require a higher amount of heat energy to facilitate the desorption of the adsorbed contaminant.

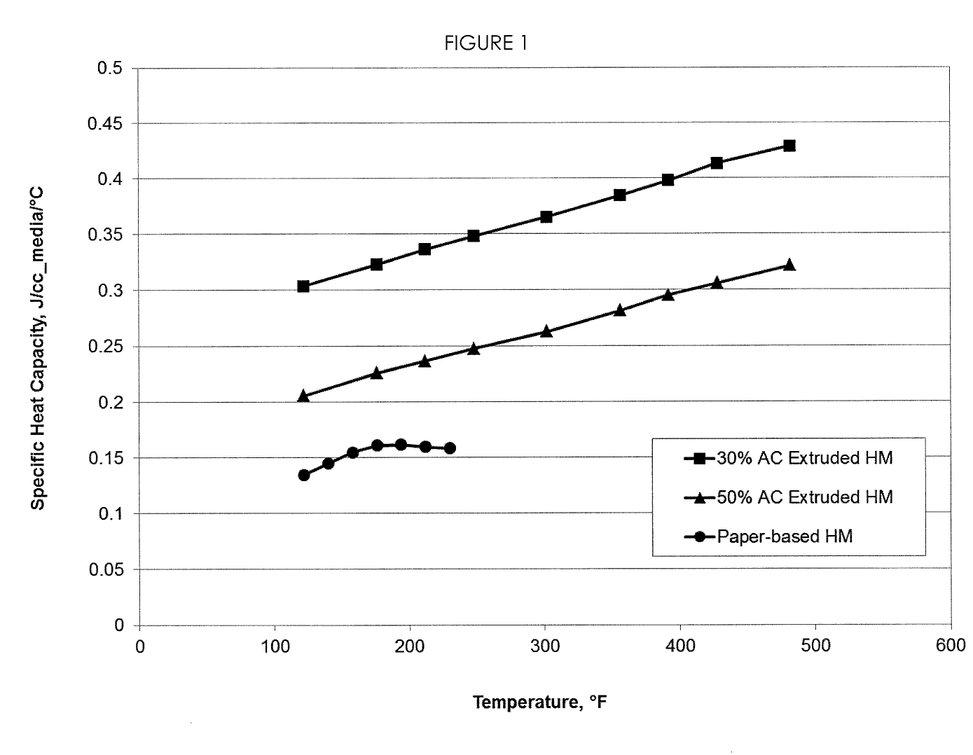

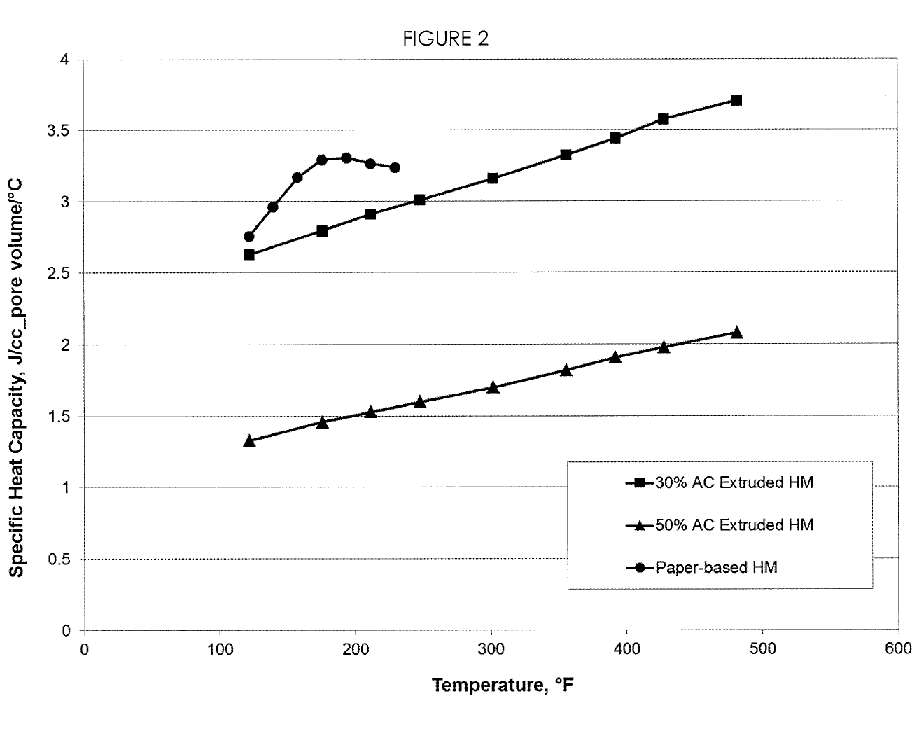

Unexpectedly, it has been found now that the extruded honeycomb adsorbent media of present disclosure has a lower specific heat capacity on a pore volume basis, compared to the honeycomb adsorbent media constructed from fibrous sheets. FIG. 1 shows a specific heat capacity per media volume of different honeycomb adsorbent media: a honeycomb adsorbent media constructed from at least one fibrous sheet (hereinafter “paper-based HM”), an extruded honeycomb adsorbent media including about 30% weight activated carbon (hereinafter “30% AC extruded HM”), and an exemplary extruded honeycomb adsorbent media of present disclosure including about 50% weight activated carbon (hereinafter “50% AC extruded HM”). The paper-based HM has a lower specific heat capacity per volume, compared to the extruded honeycomb adsorbent media (30% AC extruded HM and 50% AC extruded HM). However, as shown in FIG. 2, surprisingly the 50% AC extruded HM showed the lowest specific heat capacity per pore volume compared to the paper-based HM and the 30% AC extruded HM.

Surprisingly, the extruded honeycomb adsorbent media of present disclosure shows a lower specific heat capacity on a pore volume basis, compared to the honeycomb adsorbent media constructed from fibrous sheets. The disclosed extruded honeycomb adsorbent media requires a lower amount of energy to facilitate desorption of adsorbed contaminant than the honeycomb adsorbent media constructed from fibrous sheets.

Furthermore, it has been found that the extruded honeycomb adsorbent media having an activated carbon content of about 50% weight provides at least about 17% increase in the initial adsorption capacity compared to the extruded honeycomb adsorbent media having an activated carbon content of about 30% weight.

Moreover, it has been found that after a short desorption cycle insufficient to completely desorb the adsorbed contaminant from the extruded honeycomb adsorbent media, the extruded honeycomb adsorbent media having an activated carbon content of about 50% weight provides at least about 29% increase in the adsorption capacity compared to the extruded honeycomb adsorbent media having an activated carbon content of about 30% weight.

Thus, the disclosed extruded honeycomb adsorbent media may provide an increased adsorption capacity during adsorption cycle and an improved desorption efficiency during desorption cycle.

Honeycomb adsorbent media has replaced the particulate adsorbent media (e.g., granular or pelletized adsorbent bed) in concentrator systems at least because it offers lower flow resistance compared to the particulate adsorbent media. As the flow resistance in the adsorbent media of the concentrator systems increases, higher amounts of energy are needed to force the contaminant-laden fluid stream through the adsorbent media, resulting in higher cost to operate the concentrator systems. One skilled in the arts recognizes that the flow resistance of the extruded honeycomb adsorbent media in the concentrator systems increases as the cell density of the extruded honeycomb adsorbent media increases. Thus, one skilled in the arts would not have considered improving the performance and economy of the extruded honeycomb adsorbent media for the concentrator systems by increasing the cell density of the extruded honeycomb adsorbent media.

Surprisingly, it has been found now that the concentrator system utilizing the extruded honeycomb adsorbent media having a cell density of about 400 cpsi, % open area of 65%, a length of about 9 inches and an activated carbon content of about 50% by weight based on total weight exhibits an enhanced adsorption performance and similar pressure drop, compared to the concentrator system utilizing the extruded honeycomb adsorbent media having a lower cell density (about 200 cpsi), a larger % open area (about 73%), a longer length (about 18 inches), and a lower activated carbon content (30% by weight).

Therefore, the extruded honeycomb adsorbent media of present disclosure provides the concentrator systems with an improved adsorption capacity and enhanced desorption ability, without imparting any significant increase in flow resistance.

In a particular embodiment, a solvent concentrator system comprises at least one extruded honeycomb adsorbent media and a gas flow system. The extruded honeycomb adsorbent media is characterized by a cell density of more than about 200 cells per square inch (cspi), % open area of at least about 50%, an activated carbon content of at least about 50% by weight based on total weight, and a pressure drop of less than about 4.0 inH₂O/ft media at a superficial fluid velocity of about 500 ft/min.

In some embodiments, at least one of the extruded honeycomb adsorbent media in the solvent concentrator system may have a pore volume/media volume of at least about 0.12 cc pore volume/cc media and a specific heat capacity of less than about 2.9 J/cc pore volume.

By way of non-limiting example, large volumes of gas stream (e.g., about 30 CFM to about 70,000 CFM) containing small amounts of solvent (e.g., about 50 ppm to about 200 ppm) may be directed to the disclosed extruded honeycomb adsorbent media in the solvent concentrator system. The solvent in the solvent-laden gas stream is absorbed onto the extruded honeycomb adsorbent media. Then, relatively small volumes (e.g., about 3 CFM to about 5,000 CFM) of heated purge air having a temperature of from about 250° F. to about 500° F. may be directed to the solvent concentrator system to desorb the adsorbed solvent from the extruded honeycomb adsorbent media into the relatively small volumes of heated purge air. The relatively small volumes of solvent-laden heated purge air then exit the solvent concentrator system for further processing. The relatively small volumes of solvent-laden purge air may be directed to an incinerator system, such as a thermal oxidizer, to burn off the solvent. Alternatively, the relatively small volumes of solvent-laden heated purge air may be directed to a solvent recovery system to isolate the solvent from the purge air so that the recovered solvent may be reused.

The extruded honeycomb adsorbent media of present disclosure may be used as the adsorbent media for a rotary solvent concentrator system, which allows a continuous cleaning of the high volume solvent-laden gas flow via adsorbent media in the rotary adsorbent units, and desorbing of the spent adsorbent media in the rotary adsorbent units.

Accordingly, in one particular embodiment, a rotary solvent concentrator system comprises multiple rotary adsorbent units, each unit including at least one extruded honeycomb adsorbent media; a rotating frame for mounting the multiple rotary adsorbent units; and a gas flow system configured to direct solvent-laden gas to the adsorbent media during adsorption cycle and direct a separate clean gas stream to the adsorbent media during desorption cycle. The rotating frame has a predetermined rotational adsorption and desorption cycles. The extruded honeycomb adsorbent media is characterized by a cell density of more than about 200 cells per square inch (cspi), % open area of at least about 50%, an activated carbon content of at least about 50% by weight based on total weight, and a pressure drop of less than about 4.0 inH₂O/ft media at a superficial fluid velocity of about 500 ft/min.

In some embodiments, at least one of the extruded honeycomb adsorbent media may have a pore volume/media volume of at least about 0.12 cc pore volume/cc media and a specific heat capacity of less than about 2.9 J/cc pore volume.

In a further particular embodiment, an adsorbent media is characterized by a pore volume/media volume of at least about 0.12 cc pore volume/cc media, a specific heat capacity of less than about 2.9 J/cc pore volume, and a pressure drop of less than about 4.0 inH₂O/ft media at a superficial air velocity of about 500 ft/min, wherein an adsorbent media is in a concentrator system. The pore volume measurement is based on the volume greater than 320 angstroms as measured by N₂ porosimetry.

In some embodiments, the adsorbent media has a honeycomb structure. In some embodiments, the adsorbent media is in a solvent concentrator system.

Various adsorbent materials are suitable for the adsorbent media. The adsorbent materials may be organic materials, inorganic materials, or mixtures thereof. Non-limiting examples of suitable adsorbent materials may include activated carbon, zeolite, carbon molecular sieve, porous polymer, pillared clay, alumina, metal-organic framework materials (“MOF” materials), or silica.

In further particular embodiment, a concentrator system for removing contaminant from a fluid stream comprises at least one adsorbent media having a pore volume/media volume of at least about 0.12 cc pore volume/cc media, a specific heat capacity of less than about 2.9 J/cc pore volume, and a pressure drop of less than about 4.0 inH₂O/ft media at a superficial air velocity of about 500 ft/min.

While the present disclosure is susceptible to various modifications and alternative forms, specific embodiments have been shown by way of example in the drawings and have been described in detail herein. However, the present disclosure is not intended to be limited to the particular forms disclosed. Rather, the present disclosure is to cover all modifications, equivalents, and alternatives falling within the scope of the present disclosure as defined by the following appended claims and their legal equivalents.

1. An adsorbent media, characterized by a pore volume/media volume of at least about 0.12 cc pore volume/cc media, a specific heat capacity of less than about 2.9 J/cc pore volume, and a pressure drop of less than about 4.0 inH₂O/ft media at a superficial air velocity of about 500 ft/min, wherein the adsorbent media is in a concentrator system.

2. The adsorbent media of claim 1, comprising an adsorbent material selected from the group consisting of activated carbon, zeolite, carbon molecular sieve, porous polymer, pillared clay, alumina, metal-organic framework material, silica, and combinations thereof.

3. The adsorbent media of claim 1, wherein the adsorbent media has a honeycomb structure.

4. The adsorbent media of claim 1, wherein the adsorbent media is in a solvent concentrator system.

5. A concentrator system for removing contaminant from a fluid stream, the concentrator system comprises at least one adsorbent media having a pore volume/media volume of at least about 0.12 cc pore volume/cc media, a specific heat capacity of less than about 2.9 J/cc pore volume, and a pressure drop of less than about 4.0 inH₂O/ft media at a superficial air velocity of about 500 ft/min.

6. The concentrator system of claim 5, wherein the concentrator system is a solvent concentrator system.

7. An extruded honeycomb adsorbent media, characterized by a cell density of more than about 200 cells per square inch (cspi), % open area of at least about 50%, an activated carbon content of at least about 50% by weight based on total weight, and a pressure drop of less than about 4.0 inH₂O/ft media at a superficial fluid velocity of about 500 ft/min.

8. The extruded honeycomb adsorbent media of claim 7, characterized by a pore volume/media volume of at least about 0.12 cc pore volume/cc media.

9. The extruded honeycomb adsorbent media of claim 7, characterized by a specific heat capacity on a pore volume basis of less than about 2.9 J/cc pore volume.

10. The extruded honeycomb adsorbent media of claim 7, wherein the activated carbon is derived from a carbon precursor selected from the group consisting of wood, wood dust, wood flour, cotton linters, peat, coal, lignite, petroleum pitch, petroleum coke, coal tar pitch, carbohydrates, coconut, fruit pits, fruit stones, nut shells, nut pits, sawdust, palm, vegetables, synthetic polymer, natural polymer, lignocellulosic material, and combinations thereof.

11. A concentrator system for removing contaminant from a fluid stream, the concentrator system comprising at least one extruded honeycomb adsorbent media having a cell density of more than about 200 cells per square inch (cspi), % open area of at least about 50%, an activated carbon content of at least about 50% by weight based on total weight, and a pressure drop of less than about 4.0 H₂O/ft media at a superficial fluid velocity of about 500 ft/min.

12. The concentrator system of claim 11, wherein the at least one extruded honeycomb adsorbent media has a pore volume/media volume of at least about 0.12 cc pore volume/cc media, and a specific heat capacity on a pore volume basis of less than about 2.9 J/cc pore volume.

13. The concentrator system of claim 11, further comprising a heat supply component held in contact with or bonded to the at least one extruded honeycomb adsorbent media.

14. The concentrator system of claim 11, wherein:
the at least one extruded honeycomb adsorbent media comprises an activated carbon in an amount of at least about 50% weight based on total weight, a binder, and an electrically conductive material; and
the concentrator system further comprises an electric current supply configured to provide a current to the at least one extruded honeycomb adsorbent media during desorption cycle.

15. A solvent concentrator system, comprising:
at least one extruded honeycomb adsorbent media having a cell density of more than about 200 cells per square inch (cspi), % open area of at least about 50%, an activated carbon content of at least about 50% by weight based on total weight, and a pressure drop of less than about 4.0 inH₂O/ft media at a superficial fluid velocity of about 500 ft/min; and
a gas flow system configured to direct solvent-laden gas stream to the at least one extruded honeycomb adsorbent media during adsorption cycle and to direct a separate clean gas stream to the at least one extruded honeycomb adsorbent media during desorption cycle.

16. The solvent concentrator system of claim 15, wherein the at least one extruded honeycomb adsorbent media has a pore volume/media volume of at least about 0.12 cc pore volume/cc media and a specific heat capacity on a pore volume basis of less than about 2.9 J/cc pore volume.

17. The solvent concentrator system of claim 15, wherein the solvent concentrator system is a rotary solvent concentrator system comprising:
a multiple rotary adsorbent units, each unit including at least one extruded honeycomb adsorbent media having a cell density of more than about 200 cells per square inch (cspi), % open area of at least about 50%, an activated carbon content of at least about 50% by weight based on total weight, and a pressure drop of less than about 4.0 inH₂O/ft media at a superficial fluid velocity of about 500 ft/min;
a rotating frame for mounting the multiple rotary adsorbent units, the rotating frame having a predetermined rotational adsorption and desorption cycles; and
a gas flow system configured to direct solvent-laden gas to the at least one extruded honeycomb adsorbent media during the adsorption cycle and to direct a separate clean gas stream to the at least one extruded honeycomb adsorbent media during the desorption cycle.

18. A method of removing contaminant from fluid stream containing contaminant, the method comprising:
contacting the fluid stream containing contaminant with at least one extruded honeycomb adsorbent media in a concentrator system to adsorb the contaminant onto the at least one extruded honeycomb adsorbent media; and
desorbing the adsorbed contaminant from the at least one extruded honeycomb adsorbent media, wherein the extruded honeycomb adsorbent media has a cell density of more than about 200 cells per square inch (cspi), % open area of at least about 50%, an activated carbon content of at least about 50% by weight based on total weight, and a pressure drop of less than about 4.0 inH₂O/ft media at a superficial fluid velocity of about 500 ft/min.

19. The method of claim 18, further comprising applying heat energy to the at least one extruded honeycomb adsorbent media while desorbing the adsorbed contaminant from the at least one extruded honeycomb adsorbent media.

20. The method of claim 18, wherein desorbing the adsorbed contaminant from the at least one the extruded honeycomb adsorbent media comprises contacting the at least one extruded honeycomb adsorbent media with a heated purge stream.
